(19) United States
(12) Patent Application Publication
(10) Pub. No.: US 2011/0204841 A9
(43) Pub. Date: Aug. 25, 2011

(54) System for storing electrical energy

(76) Inventors: R. Ian MacDonald, Nanoose Bay (CA); Neil Teitelbaum, Ottawa (CA)

(21) Appl. No.: 12/654,049

(22) Filed: Dec. 9, 2009

Related U.S. Application Data
(60) Provisional application No. 61/239,112, filed on Sep. 2, 2009.
(60) Provisional application No. 61/169,915, filed on Apr. 16, 2009.

(51) Int. Cl. H01M 8/04; H01M 8/06

(52) U.S. Cl. 320/101; 429/400; 361/287

(57) ABSTRACT

A method and apparatus are described for storing electrical power in the form of relative chemical potential between a concentrated solution, typically salt brine, and a dilute version of the same solution. To recover the power, the concentrated solution and dilute solution are supplied to a means for transforming the difference in their chemical potential into electrical power by such means as pressure retarded osmosis or reverse electrodialysis. In operation such means take in the concentrated and dilute solutions and exhaust a solution of intermediate concentration. The concentrated solution is supplied from a container such as a pond. It is generated by evaporation of the intermediate concentration solution in a second, separate pond, which receives the exhaust from the power generation means. The exhaust solution is concentrated by evaporation and is transferred into the first pond when the concentration has reached a sufficient level. To obtain a high evaporation rate in a relatively small evaporation area, the evaporation is enhanced to a rate faster than that obtained at the liquid surface of an open pond of the solution by employing electrical evaporation enhancement means. The electrical evaporation enhancement means is programmed to draw power from an electrical supply grid during periods when electricity demand is low and or when the cost of electricity is below or equal to an average cost over a period such as a diurnal cycle. When demand is high the enhancement is discontinued and the power generation means uses the stored concentrated brine to generate extra electrical power. Therefore the enhancement means would be used less than 30% of the time when the stored concentrated brine is being used to generate electrical power.

### CROSS-REFERENCE TO RELATED APPLICATIONS

The present invention claims priority from U.S. Patent Application No. 61/239,112 filed Sep. 2, 2009, which is incorporated herein by reference for all purposes.

### FIELD OF THE INVENTION

This invention relates to a method and system for storing energy during times when the cost of electricity is below or equal to an average cost or a first cost, and to utilizing the stored energy during times when electricity is above an average cost or the first cost; and more particularly to an automated system that provides a concentration difference between two solutions and utilizes that concentration difference to provide electricity in high demand periods.

### BACKGROUND OF THE INVENTION

It is difficult to alter the supply of electricity from an electricity distribution grid to adapt to changes in local demand. One solution is to store energy locally during periods of low demand and use the stored energy to produce power during periods of high demand, allowing the overall supply to be relatively constant. However it is difficult to store energy on the scale required, which may be of the order of gigaWatt hours. The most practical available method is to pump water into an elevated reservoir to store energy as hydraulic head, and recover it by allowing the water to fall back through hydroturbines. Hydroturbines that can also act as pumps have been developed for the purpose.

Places where energy storage is required may not have suitable topology for the construction of a large elevated water reservoir. To address this difficulty it has been proposed to place the reservoir in an excavated underground cavern, and to supply it with surface water to generate power, the water being pumped back to the surface in low demand periods. Very large and costly mining operations are required, as the caverns must be placed hundreds of metres underground. Such installations require economics of scale and are suitable only for very large power storage requirements. Their use is constrained by the geology of the area, since not all rock types will allow such an installation. Both methods of using hydraulic head for energy storage require long planning times and large capital investment.

It has come to be understood that significant amounts of energy can be captured in the form of differences of solution concentration and converted into electrical energy. Concentration differences are created in nature when fresh water is evaporated from the oceans and delivered to land areas. Fresh and salt water, which are saline solutions of differing concentration, come into proximity at the mouths of rivers. The salinity difference between them constitutes a chemical potential that can provide significant energy generation. Methods and means of generating electrical power from the difference in concentration of two solutions include pressure-retarded osmosis, (PRO)—(Loeb, U.S. Pat. No. 3,906,250), reverse electrodialysis, (RED)—(Loeb, U.S. Pat. No. 4,171,409) and capacitive generation (D. Brogioli—Phys Rev Lett. 102,058501, (2009)).

The availability of saline solutions having a difference in salinity has a direct impact on the power-production capability of such power generators. Where naturally occurring salinity differences are used, such as that between river and sea water, or that between a salt lake and a river or sea, the supply of both solutions is essentially unlimited. Where a supply of concentrated solution is lacking it is possible to create it from a dilute one. Furthermore, the concentrated solution can be stored, thus providing a method of storing energy. Static water solutions can be concentrated by solar and wind driven evaporation in natural salt lakes and artificial ponds. Where the concentration difference is provided by such local evaporation, the rate of supply of the concentrated solution is a limiting factor on the amount of power that can be generated and the area required for the evaporation pond will be large. Loeb (U.S. Pat. No. 3,906,250) addressed this problem by using the solar collector as a heat source that provides for the redistillation of the mixed solutions after the PRO power generation step. Similarly, concentration stratification by solar thermal input can provide a concentration difference in a relatively small area. Neither method, however, provides sufficient reconcentration rate for large-scale storage of electrical energy.

In waste treatment it is known to remove water from wastewater in order to concentrate the waste or sludge for subsequent disposal. Evaporation in ponds is used for such concentration. It is known that a rate of evaporation is enhanced considerably over the rate obtainable at the open surface of a body of fluid such as a pond can be obtained by methods such as atomisation of the fluid. In the mining industry, among others, it is a common practice to evaporate water on a large scale from contaminated effluents using powered atomisers in order to concentrate the waste for further processing. The evaporators used are electrically driven ducted fans with atomising nozzles that spray the wastewater into high velocity winds generated by the fans. The atomised spray is directed back at the tailings pond. Such evaporators typically use 15 to 25 kW to drive the fan, and in good conditions can evaporate up to 144,000 gallons per day (6.3 litres/sec). The liquid remaining in the tailings pond is thereby concentrated.

It is an object of this invention to provide for the storage of electrical energy in the form of concentrated brine by using electrical energy to drive evaporators that concentrate the brine when the electricity is least expensive in off-peak usage hours, and recover the energy during peak usage hours by delivering the brine to an electrical power production installation that produces electricity from solution concentration difference.

### SUMMARY OF THE INVENTION

In accordance with an aspect of this invention there is provided, a system for storing electrical energy comprising an electrically powered evaporator for evaporating water from a first solution at a greater rate than the evaporation from the liquid surface of a body of the fluid and thereby to provide a more concentrated second solution during a period of time T₁, when the cost of electricity is a first cost;

storage means for storing the second solution or salt;

electrical power generator for generating electricity from the difference of chemical potential between solutions of differing concentration during a time period Tₕ, when the cost of electricity is second higher cost; and,

a controller for controlling the operation of the electrically powered evaporator and the electrical power generator during times T₁ and Tₕ respectively.

In accordance with another aspect of the invention there is provided, A method for storing electrical energy comprising:

a) during a period of time T₁ when the cost of electricity is a first cost C₁ or less, electrically powering an evaporator so as to evaporate water from a first solution at a greater rate than the evaporation from the liquid surface of a body of the fluid and thereby to provide a more concentrated second solution or salt;

b) storing the second solution or salt;

c) generating electrical power from the difference of chemical potential between solutions of differing concentration during a time period Tₕ when the cost of electricity is higher than C₁ wherein one of said solutions of differing concentrations is the first solution, the second, or a solution having the salt therein.

In accordance with the invention there is provided, a method for storing electrical energy comprising:

a) during a period of time T₁ when the cost of electricity is below to an average cost during a predetermined period, electrically powering an evaporator evaporating water from a first solution at a greater rate than the evaporation from the liquid surface of a body of the fluid and thereby to provide a more concentrated second solution or salt;

b) storing the second solution or salt;

c) generating electrical power from the difference of chemical potential between solutions of differing concentration during a time period Tₕ when the cost of electricity is higher than an average cost during the predetermined period, wherein one of said solutions of differing concentrations is the first solution, the second, or a solution having the salt therein.

In accordance with another aspect of the invention, there is provided a system for storing electrical energy comprising:

an electrically powered evaporator for evaporating water from a first solution at a greater rate than the evaporation from the liquid surface of a body of the fluid and thereby to provide a more concentrated second solution during a period of time T₁ when the cost of electricity is below an average cost during a 24 hour cycle;

storage means for storing the second solution or salt from the second solution; electrical power generator for generating from the difference of chemical potential between solutions of differing concentration during a time period Tₕ when the cost of electricity is higher than an average cost during a 24 hour cycle; and

a controller for controlling the operation of the electrically powered evaporator and the electrical power generator during times T₁ and Tₕ respectively.

### BRIEF DESCRIPTION OF THE DRAWINGS

Exemplary embodiments will now be described in conjunction with the drawings in which:

FIG. 1 is a schematic diagram illustrating a system in accordance with this invention which is capable of storing a brine solution and increasing the concentration by atomizing the solution in off-peak electricity demand times.

FIG. 2 is a schematic diagram of a controller, which controls when the system of FIG. 1 is to be producing high concentration brine and when it is to be converting stored brine to electricity to be fed back to the power grid.

### DETAILED DESCRIPTION

Electrical power may be derived from the difference in concentration of two instances of the same solution, typically salt dissolved in water, using means for power generation. Means for power generation includes a concentration based electrical generator which may be a pressure retarded osmosis system, or a reverse electrodialysis system, or a capacitive system. Such power generation means is provided with a concentrated solution and a dilute solution, and in the process of generating power creates an exhaust solution of intermediate concentration. The exhaust solution is preferably delivered to a means for reconcentration. Means for reconcentration includes a reservoir such as a pond or other type of holding container, and an electrically driven means for increasing the concentration, can be provided by an atomizer, for providing a high rate of evaporation of the solvent in order to reconcentrate the exhaust solution.

This invention is based on using an electrically powered evaporation enhancer such as an atomizer and or heater, which is programmed to be used during times when electricity costs are relatively low. Alternatively water can be passed along plates to increase evaporation. Preferably a supply reservoir is provided for supplying a reconcentrated solution to the power generation system. When the exhaust solution has been reconcentrated sufficiently to become a concentrated solution it is transferred from the means for reconcentration to the supply reservoir. Because the supply reservoir and the means for reconcentration are separate in this implementation the concentration of the supply remains constant when the means for power generation is in operation.

The reservoirs may be constructed as ponds or shallow underground caverns. They may be roofed to prevent dilution by rainfall. Electrically enhanced evaporation may be obtained by atomization, heating, or other methods.

In an alternative embodiment one or both reservoirs may be equipped with pontoons or other flotation means so as to provide enough buoyancy to float the reservoirs on an ocean or other body of water. This would obviate providing expensive land to accommodate these massive reservoirs.

Therefore in use the power generation system may be located on a suitable area of land that has access to low concentration solution, for example fresh water, or may be floating on water that may itself constitute one of the solutions used in the power generation system, for example in the sea. The solution to be concentrated by evaporation and rediluted in the process of power generation may be a natural solution such as seawater, or may be a solution formulated for the purpose of power generation, for example a solution with a solute of high molecular weight that can be concentrated to give a higher relative osmotic pressure than can be obtained with concentrated and dilute seawater. It should be noted that the solute is recovered in the power generation process.

In operation to provide power from stored concentrated solution the flow F from the supply reservoir is turned on and the electrically driven evaporator means in the means for reconcentration is turned off. The exhaust from means for power generation is stored in the reservoir within means for reconcentration for a period of time Tpower, until the requirement to produce power is over. At that point, which marks the beginning of the storage period, Tstorage, the flow F is turned off and the electrically driven evaporator means is turned on. The stored exhaust is concentrated by evaporation during time period Tstorage. When the concentration has reached the required level Cs, the fluid may be transferred to the supply reservoir ready for the next period of power generation. Depending on the length of the power and storage portions of the cycle, additional dilute fluid may be processed by the reconcentrator to increase the amount of stored energy available.

In a particular embodiment, and by way of example, a system for producing power from seawater using the PRO technique is described. During Tpower means for power generation supplies to the generator a flow F (m³/s) of brine with concentration Cs from a supply reservoir. In the process of electricity generation the flow F is diluted to concentration Cop by a flow f of pure water, which is extracted from the dilute solution in passing an osmotic membrane. The exhaust of the means for power generation consists of the combined flows F and f, at concentration Cop, and this is delivered to the means for reconcentration. There is thus a net flow f of pure water entering the reservoir within means for reconcentration during the power generation period Tpower. The volume of fresh water that is accumulated during this period must be removed by evaporation during the storage period Tstorage, therefore

Tpower*f=Ev*N*Tstorage Eq. 1

where Ev is the evaporation rate achieved by one electrically driven means for concentration and N is the number of these in the means for reconcentration.

The osmotic pressure Pop (Pa) in the osmotic chamber is determined by the steady state concentration of the mixture of the water permeate and the brine entering from the supply reservoir. The osmotic pressure is partially countered by hydrostatic pressure applied on the brine side of the osmotic membrane. Maximum power is generated when this “retarding” pressure is half the osmotic pressure. The permeation flow is therefore

f=Amembrane Aperm Pop/2 Eq. 2

where Aperm (m/s-Pa) is the permeation coefficient and Amembrane is the area (m̂2) of the osmotic membrane. An empirical approximation to the performance of available membranes for forward osmosis is given by Jan W. Post et. Al. (Journal of Membrane Science 288 (2007) 218-230) in the form

Aperm=4.8*10⁻¹²*(Pop/2*10⁻⁵)^{-0.8} Eq. 3

Equations 1, 2 and 3 can be solved to give an expression for the operating pressure Pop:

Pop=7.85*10³⁶(Ev*N*Tstorage/Tpower)⁵/Amembrane⁵ Eq.4

The power W that is generated is given by the product of the permeation flow f and the operating hydrostatic pressure:

W=Amembrane Aperm Pop²/4

=3.92*10³⁶(Ev*N*Tstorage/Tpower)⁶/Amembrane⁵ Eq. 5

This result is independent of the concentration of the solution in the pond or the rate of recirculating flow F. However a practical limit to the operating concentration is the solubility of the solute.

During the power generation period a volume of water Ton (f+F) is exhausted to the reservoir in the means for reconcentration.

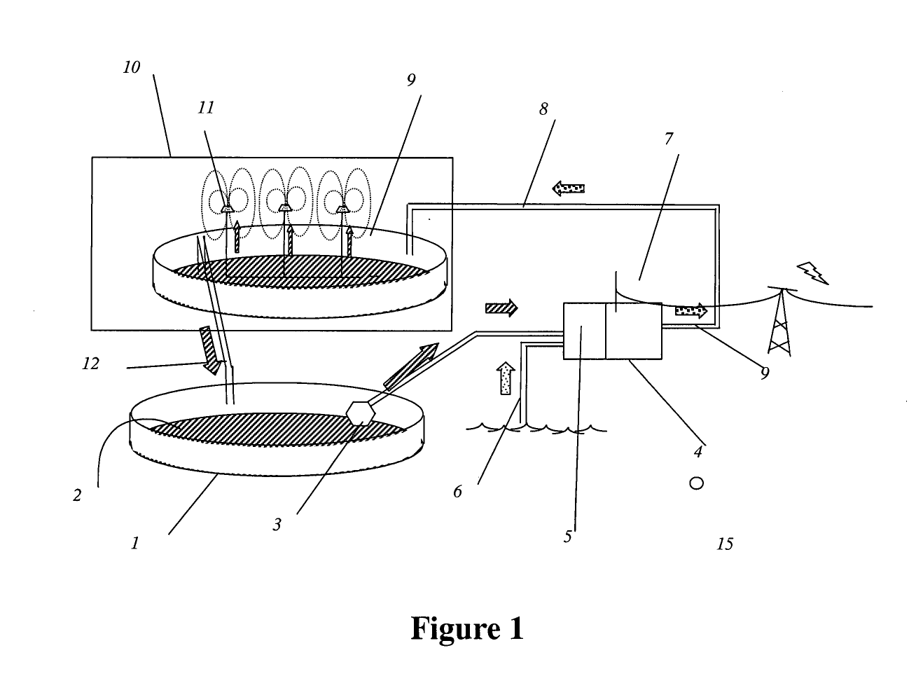

The operation of the system of FIG. 1 will now be described. A supply reservoir 1 contains solution 2 at concentration Cs. The supply reservoir can be any form of walled container that will hold the saline solution provided by the reconcentrator 10. The solution within the reservoir 1 is delivered by means of a pump 3 or by gravity to means for power generation 4 at a flow rate F controlled by a controller 18. In operation, in a PRO implementation for power generation the incoming flow F enters an osmotic cell 5, which is also supplied with freshwater or low concentration solution 6. The output of means for power generation is electrical power 7 and an exhaust flow 8 of relatively diluted solution at concentration Cop and a flow rate F+f. The exhaust is delivered to a collection reservoir 9 constituting part of means for reconcentration 10. Means for reconcentration 10 in the form of an atomizing reconcentrator controlled by the controller 18 is provided with electrically driven means for evaporation 11, for example ducted fan atomisers. A connection 12 from the collection reservoir 9 of means for reconcentration 10 to the supply reservoir 1 that feeds means for power generation 4 provides for the transfer of solution when it has been sufficiently concentrated. The controller only powers the evaporation means 11 when the cost of electricity is below a predetermined amount or upon an event related to the low cost of electricity and when the supply reservoir is not above a predetermined level.

In an alternative configuration it may be possible to supply solution 2 to means for power generation 4 directly from the collection reservoir 9 of means for reconcentration 10 thus eliminating one reservoir, provided that the dilution of the fluid in the reservoir 9 by the exhaust flow 8 during the operation period can be tolerated. In such operation the means for evaporation 11 may be operated, possibly at a reduced level, during the power production period Tpower.

By way of example, consider a system designed to provide 25 kW power for eight hours in every 24 using pressure retarded osmosis as the means for power generation 4. The dilute solution 6 is seawater, and the concentration of the supply solution 2 is 315 ppt, about nine times the concentration of typical seawater. The osmotic membrane must have an area of 4560 sq m to provide the power required, and the exhaust concentration is 200 ppt. The required evaporation rate to reconcentrate eight hours worth of exhaust within sixteen hours is 40 gallons per minute. This evaporation rate is achievable in reasonable conditions by a commercially available turbine evaporator that consumes 25 kW. The calculation assumes a 95% efficiency in pressure recovery and 90% efficiency of flow to electrical power conversion in the means for power generation.

For large scale power storage it is necessary only to scale up the sizes of the reservoirs and increase the number of evaporators. 100 MW can be delivered for eight hours out of every 24 by a storage system using 4000 of the same evaporation units under the same evaporation conditions. The reservoirs require to contain 1,000,000 cu m of water in this case. A reconcentrator reservoir 1 metre deep and 10 km long in the direction transverse to the prevailing wind and 100 m wide in the wind direction could accommodate the evaporation units on a grid throughout the reservoir, with each unit separated from the next by 10 metres in the direction transverse to the wind, and 25 metres in the direction of the wind. Such a reservoir could be folded so that the 10 km length is accommodated in a more compact area. The supply reservoir for such a system can be 30 metres deep and 200 metres square. Such a reservoir could be roofed to prevent rain from diluting the stored brine.

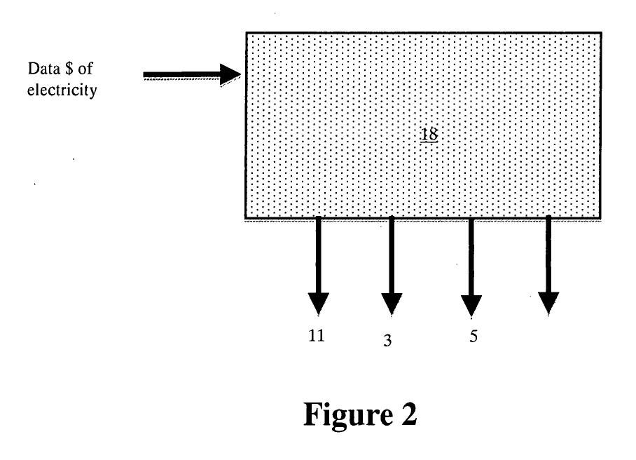

Referring now to FIG. 2 a controller is shown, having a microcontroller processor, memory, input ports for receiving real time information and having controller output ports for controlling the switching on and off of the evaporation means 11 and means for power generation 4, independently. In most instance the evaporation means will be switched on when the means for power generation 4 is switched off, and vice versa.

In a preferred embodiment, when the cost of electricity is above an average cost, the evaporation means 11 is be switched off by the controller 18, and the means for power generation will be switched on, thereby generating power using the stored solution in the supply reservoir 1. Alternatively when the cost of electricity is less than an average cost, and if the supply reservoir is below a predetermined level, the evaporation means 11 will be switched on and the means for generating power will be switched off. The controller also controls the flow of solution to 4 by controlling pump 3. The movement of solutions that are monitored by flotation level switches are also controlled by the controller 18.

In one embodiment, the controller 18 uses real-time input signals that correspond to the real-time cost of electricity related to the grid the system is coupled with. In another embodiment the controller is programmed to control the system based on a clock that is coupled with data related to the cost of electricity. In this instance, based on the time of day/night, the system either consumes electricity to provide a concentrated solution, or delivers electricity produced from a difference of the salinity of a stored concentrated solution and a more dilute solution.

What is claimed is:

1. A system for storing electrical energy comprising:
(a) an electrically powered evaporator for evaporating water from a first solution at a greater rate than the evaporation from the liquid surface of a body of the fluid and thereby to provide a more concentrated second solution during a period of time Tₕ when the cost of electricity is a first cost;
(b) collection means for collecting the second solution of salt;
(c) electrical power generator coupled to receive the second solution of salt for generating electricity from the difference of chemical potential between the second solution and a more dilute solution during a time period Tₕ when the cost of electricity is second higher cost; and,
(d) a controller for controlling the operation of the electrically powered evaporator and the electrical power generator during times T₁ and Tₕ respectively.

2. A system for storing electrical energy as defined in claim 1 where the electrically powered evaporator includes an atomizer for atomizing the first solution or a means for distributing the solution over a surface or a heater, for increasing evaporation.

3. A system for storing electrical energy as in claim 2 where the electrical power generator includes one of Pressure Reduced Osmosis System in combination with a hydroturbine, reverse electrodialysis system and, capacitor means for power generation.

4. A system for storing electrical power as in claim 1 including means for delivering a dilute solution from the electrical power generator to means for reconcentration.

5. A system for storing electrical power as in claim 1 including a reservoir to receive reconcentrated fluid from the collection means.

6. A system for producing electrical power as in claim 5 including controllable means for delivering the second solution from the reservoir or from the collection means to the electrical power generator

7. A system as defined in claim 5 wherein the electrically powered evaporator and the collection means are equipped with floatation for floating upon a body of water.

8. A method for storing electrical energy comprising:
a) during a period of time T₁ when the cost of electricity is a first cost C₁ or less, electrically powering an evaporator so as to evaporate water from a first solution at a greater rate than the evaporation from the liquid surface of a body of the fluid and thereby to provide a more concentrated second solution or salt;
b) storing the second solution or salt;
c) generating electrical power from the difference of chemical potential between solutions of differing concentration during a time period Tₕ when the cost of electricity is higher than C₁ wherein one of said solutions of differing concentrations is the first solution, the second, or a solution having the salt therein, wherein steps (a) and (c) are controlled automatically by a controller.

9. A method as defined in claim 8, wherein the controller is processor-controlled controller capable of switching the electrically powered evaporator on and off and capable of switching an electrical generator off and on, in dependence upon external inputs.

10. A method as defined in claim 8, wherein the controller is responsive to external input signals that provide an indication of the real-time cost of electricity.

11. A method as defined in claim 8 wherein step (b) includes storing the second solution or salt in a reservoir, and wherein the controller controls the flow of fluid out of the reservoir

12. A method as defined in claim 11, wherein the controller controls the flow of the concentrated second solution into the reservoir.

13. A method as defined in claim 8 further comprising the step of containing the second solution in a first holding container, prior to performing step (b).

14. A method as defined in claim 8 wherein the second solution is monitored to determine its salinity.

15. A method as defined in claim 8 wherein the controller in dependence upon pricing information related to the cost of electricity, switches on the evaporator and ceases to generate electrical power, or vice versa.

16. A method as defined in claim 8 comprising the step of evaporating is performed by atomizing the first solution, passing the first solution over an evaporating surface, or heating the first solution.

17. A method as defined in claim 16 wherein the step of generating electric power including using one of: a) Pressure Reduced Osmosis in combination with a hydroturbine; b) reverse electrodialysis; and c) capacitor electrical conversion means.
